(19) United States
(12) Patent Application Publication
(10) Pub. No.: US 2025/0187656 A1
(43) Pub. Date: Jun. 12, 2025

(54) OPTIMAL SLIP ANGLE STEERING CONTROL FOR VEHICLES

(71) Applicants: Constructor Autonomous AG, Schaffhausen (CH); Constructor Education and Research Genossenschaft, Schaffhausen (CH)

(72) Inventors: Maksim Filipenko, Batumi (GE); Ilya Shimchik, Zurich (CH); Serg Bell, Costa del Sol (SG); Stanislav Protasov, Singapore (SG); Nikolay Dobrovolskiy, Istambul (TR)

(21) Appl. No.: 18/533,846

(22) Filed: Dec. 8, 2023

(51) Int. Cl. B62D 6/00

(52) U.S. Cl. CPC B62D 6/006; B62D 6/001; B62D 6/002

(57) ABSTRACT

Systems and methods for optimizing steering angle of a vehicle. Controlling a vehicle implementing steer-by-wire including independent steering control for a wheel of the vehicle includes collecting environmental information about the vehicle, preparing an ideal steering plan for the vehicle, receiving a vehicle goal, collecting current vehicle information, determining a slip angle for the wheel, and actuating the independent steering control for wheel according to the slip angle.

### TECHNICAL FIELD

The current invention relates generally to vehicle steering. More particularly, the invention relates to optimal slip angle steering control.

### BACKGROUND

The goal of any racing car is to achieve the minimum lap time possible. Thus, it is crucial to maximize cornering speed. In particular, it is important to extract maximum cornering force from the vehicle's tires to achieve maximum cornering speed, which can be achieved when the tires work at optimal slip angles.

The Ackermann steering geometry is a geometric arrangement of linkages in the steering of a car or other vehicle designed to solve the problem of wheels on the inside and outside of a turn needing to trace out circles of different radii, which is commonly used for racing cars. However, the Ackerman steering geometry does not provide optimal slip angles for tire force maximization for both tires for each corner on the track.

Accordingly, there is a need for an improved steering scheme and improved vehicle control.

### SUMMARY

Embodiments described herein, or otherwise contemplated, substantially meet the aforementioned needs of the industry. Embodiments described herein increase the performance of a vehicle using optimal slip angle.

In a feature and advantage of embodiments, a control problem is split into subproblems for the purpose of optimizing slip angle. For example, control can be split into localization, state estimation, sensor fusion, and system identification problems. In embodiments, a module coordinating solutions to each of the respective problems can implement a trained model specialized in such problems. Accordingly, control algorithms are simplified.

In an embodiment, a method for controlling a vehicle implementing steer-by-wire including independent steering control for at least one wheel of the vehicle comprises collecting environmental information about the vehicle, the environmental information including a track configuration and at least one vehicle parameter; preparing an ideal steering plan for the vehicle using a model based on the environmental information; receiving at least one vehicle goal; collecting current vehicle information including identification data, mapping data, localization data, sensor data, and state estimation data for the vehicle; determining a slip angle for the at least one wheel based on the current vehicle information applied to the model for the at least one vehicle goal; and actuating the independent steering control for the at least one wheel of the vehicle according to the slip angle.

In an embodiment, a system for controlling a vehicle using at least one system goal comprises a plurality of sensors configured to detect data associated with the vehicle; an artificial intelligence (AI) subsystem including: an offline engine configured to operate on existing information associated with the vehicle, the offline engine including an optimal control module configured to generate an ideal plan as a model for the vehicle based on mapping data, tire dynamics data, and vehicle dynamics data; and an online engine configured to operate on dynamic data associated with the vehicle, the online engine including: an identification module configured to determine static and dynamic vehicle parameters during vehicle operation, a sensor fusion module configured to synthesize data from a plurality of sensors associated with the vehicle to generate fused data, a state estimation module configured to determine a current state of the vehicle based on the fused data, a localization module configured to determine a location of the vehicle, a trajectory planning module configured to determine at least one slip angle for a wheel of the vehicle based on the at least one system goal applied to the ideal plan, according to the static and dynamic vehicle parameters during vehicle operation, the current state of the vehicle, and the location of the vehicle, and a control module configured to generate a command according to the slip angle; and a steer-by-wire subsystem including an actuator associated with at least one wheel of the vehicle for independent steering control of the at least one wheel and configured to actuate the at least one wheel according to the command.

In an embodiment, a method for controlling a vehicle comprises solving a localization problem for the vehicle by determining a location of the vehicle; solving an estimation problem for the vehicle by determining a current state of the vehicle; solving an identification problem for the vehicle by determining static and dynamic vehicle parameters during vehicle operation; generating at least one system goal; receiving a change in wheel steering input; computing at least one steering angle for a wheel of the vehicle based on the at least one system goal, the location of the vehicle, the current state of the vehicle, and the static and dynamic vehicle parameters; and commanding a steer-by-wire subsystem to actuate the wheel of the vehicle according to the at least one steering angle.

### BRIEF DESCRIPTION OF THE DRAWINGS

Subject matter hereof may be more completely understood in consideration of the following detailed description of various embodiments in connection with the accompanying figures, in which:

FIG. 1 is a block diagram of a vehicle including toe-in and toe-out tire direction, according to an embodiment.

FIG. 2 is a diagram of a vehicle including steering control parameters and slip angles, according to an embodiment.

FIG. 3 is a diagram of a wheel of the vehicle of FIG. 2, according to an embodiment.

FIG. 4 are graphs of nonlinear tire models for calculating lateral forces, according to an embodiment.

FIG. 5 is a block diagram of a steer-by-wire subsystem, according to an embodiment.

FIG. 6 is a block diagram of a system for optimal slip angle steering control of a vehicle, according to an embodiment.

FIG. 7 is a block diagram of a system for optimal slip angle steering control of a vehicle, according to an embodiment.

FIG. 8 is a block diagram of a track for a vehicle, according to an embodiment.

FIG. 9 is a flowchart of a method for slip angle steering control of a vehicle, according to an embodiment.

FIG. 10 is a flowchart of a method for slip angle steering control of a vehicle, according to an embodiment.

### DETAILED DESCRIPTION

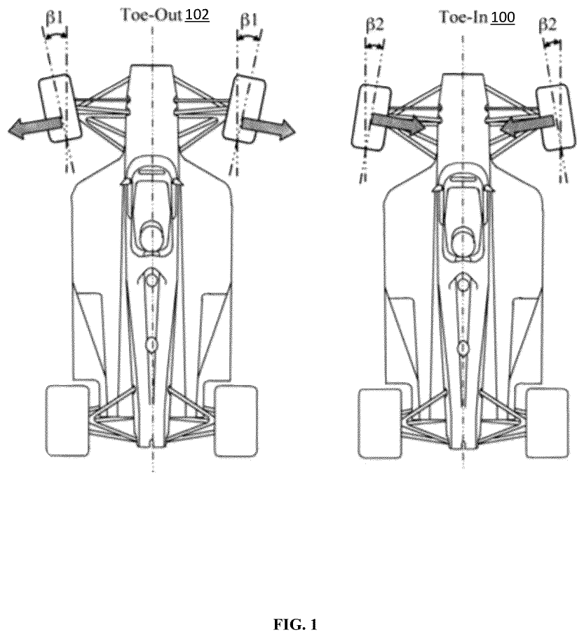

Referring to FIG. 1, a block diagram of a vehicle including toe-in tire direction 100 and toe-out tire direction 102 is depicted, according to an embodiment. Toe, also known as tracking, is the symmetric angle that each wheel makes with the longitudinal axis of the vehicle, as a function of static geometry, and kinematic and compliant effects. This can be contrasted with steer, which is the antisymmetric angle, i.e. both wheels point to the left or right, in parallel (roughly). Negative toe, or toe out 102, is the front of the wheel pointing away from the centerline of the vehicle. Positive toe, or toe in 100, is the front of the wheel pointing towards the centerline of the vehicle. According to the toe, an artificial slip angle and lateral grip can be created.

In an embodiment, a slip angle is the angle between the direction in which a wheel is pointing and the direction in which it is actually traveling. This slip angle results in a force, the cornering force, which is in the plane of the contact patch and perpendicular to the intersection of the contact patch and the midplane of the wheel. This cornering force increases approximately linearly for the first few degrees of slip angle, then increases non-linearly to a maximum before beginning to decrease.

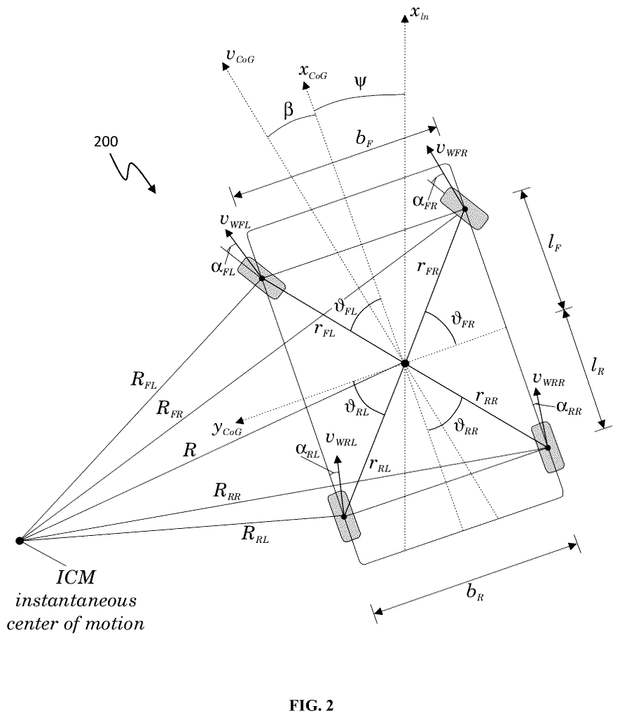

Referring to FIG. 2, a diagram of a vehicle 200 including steering control parameters is depicted, according to an embodiment. In an embodiment, parameters used for steering control for vehicle 200 include:

### Example of Car Parameters:

m—vehicle mass
Ix—moment of inertia about the x-axis [kg m\hat{ }2]
Iy—moment of inertia about the y-axis [kg m\hat{ }2]
Iz—moment of inertia about the z-axis [kg m\hat{ }2]
a—distance of the CoG from the front axle [m]
b—distance of the CoG from the rear axle [m]
h—CoG height [m]
wf—track front length [m]
wr—track rear length [m]
Rf—front wheel radius [m]
Rr—front wheel radius [m]
   V_{WFL}: front left wheel velocity
   V_{WFR}: front right wheel velocity
   V_{WRL}: rear left wheel velocity
   V_{WFR}: rear right wheel velocity
   r_{FL}: distance from center of gravity (CoG) to front left wheel ground contact point
   r_{FR}: distance from CoG to front right wheel ground contact point
   r_{RL}: distance from CoG to rear left wheel ground contact point
   r_{RR}: distance from CoG to rear right wheel ground contact point
   ν_{FL}: angle between chassis (CoG) coordinate system and front left wheel ground contact point
   ν_{FR}: angle between chassis (CoG) coordinate system and front right wheel ground contact point
   ν_{RL}: angle between chassis (CoG) coordinate system and rear left wheel ground contact point
   ν_{RR}: angle between chassis (CoG) coordinate system and rear right wheel ground contact point
   l_{f}: distance from CoG to front axle
   lᵣ: distance from CoG to rear axle
   b_{F}: distance between wheels on front axle
   b_{R}: distance between wheels on rear axle

Vehicle 200 of FIG. 2 is further depicted with slip angles, according to an embodiment. For example, alpha_fl (α_{FL}) depicts the front left wheel slip angle, alpha_fr (α_{FR}) depicts the front right wheel slip angle, alpha_rl (α_{RL}) depicts the rear left wheel slip angle, and alpha_rr (αRR) depicts the rear right wheel slip angle. Further depicted is the relative instantaneous center of motion (ICM) relative to each of the wheels.

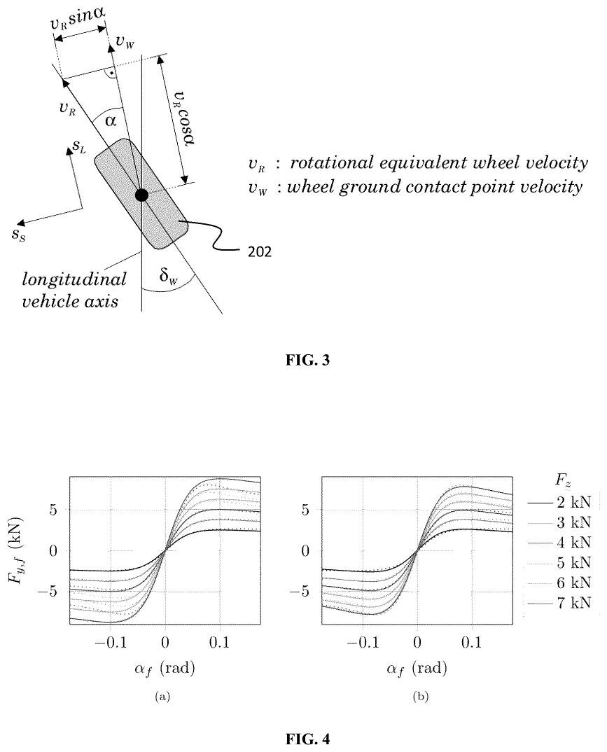

Referring further to FIG. 3, a diagram of a wheel 202 of vehicle 200 of FIG. 2 including a wheel slip calculation is depicted, according to an embodiment. In particular, in order to define individual lateral tire slip angle, definition for two variables is depicted. These variables are used to define slip angle. As illustrated, V_{R} is the rotational equivalent wheel velocity, and V_{W} is the wheel ground contact point velocity. According to TABLE 1 below, longitudinal slip and side slip can be calculated.

TABLE 1

| | Braking | Driving |
|---|---|---|
| | v_{R} cos α ≤ v_{W} | v_{R} cos α ≥ v_{W} |
| Longitudinal slip | ${s}_{L} = \frac{{v}_{R} cos α - {v}_{W}}{{v}_{W}}$ | ${s}_{L} = \frac{{v}_{R} cos α - {v}_{W}}{{v}_{R} cos α}$ |
| Side slip | ${s}_{S} = \frac{{v}_{R} \cdot sin α}{{v}_{W}}$ | s_{S} = tan α |

In an embodiment, slip angles can be calculated according to TABLE 2 below, where delta_w_fl (δF_{L}), delta_w_fr (δF_{R}), delta_w_rl (δRL) and delta_w_rr (δRR) are steering angles. Steering angles can be controlled by the proposed steering scheme described herein, since it is possible to achieve a desired slip angle.

TABLE 2
${α}_{FL} = {δ}_{FL} - arctan ( \frac{{v}_{CoG} β + \dot{ψ} {r}_{FL} cos {ϑ}_{FL}}{{v}_{CoG} - \dot{ψ} {r}_{FL} sin {ϑ}_{FL}} )$
${α}_{FR} = {δ}_{FR} - arctan ( \frac{{v}_{CoG} β + \dot{ψ} {r}_{FR} sin {ϑ}_{FR}}{{v}_{CoG} + \dot{ψ} {r}_{FR} cos {ϑ}_{FR}} )$
${α}_{RL} = {δ}_{RL} - arctan ( \frac{{v}_{CoG} β - \dot{ψ} {r}_{RL} sin {ϑ}_{RL}}{{v}_{CoG} - \dot{ψ} {r}_{RL} cos {ϑ}_{FL}} )$
${α}_{RR} = {δ}_{RR} - arctan ( \frac{{v}_{CoG} β - \dot{ψ} {r}_{RR} cos {ϑ}_{RR}}{{v}_{CoG} + \dot{ψ} {r}_{RR} sin {ϑ}_{RR}} )$

In an embodiment, a slip angle is determined for at least one wheel. In an embodiment, slip angles are determined for the two front wheels. In another embodiment, slip angles are determined for all four wheels. In an embodiment, slip angles are determined for any subset of all four wheels, such as one front and one rear. Embodiments described herein therefore are applicable to steering controls for any vehicle. For example, vehicles customized for driving can include all four wheels pointing relatively outward.

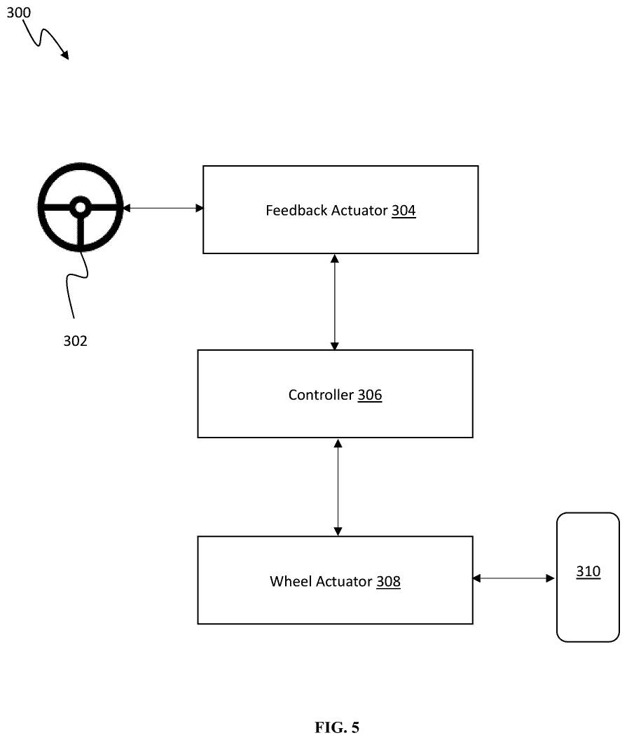

Referring to FIG. 4, graphs of nonlinear tire models for calculating lateral forces are depicted, according to an embodiment. As illustrated, lateral forces Fy,ij depend on slip angle. Thus, slip angle can be controlled by the steering scheme described herein since that the lateral tire force of front wheels can be controlled.

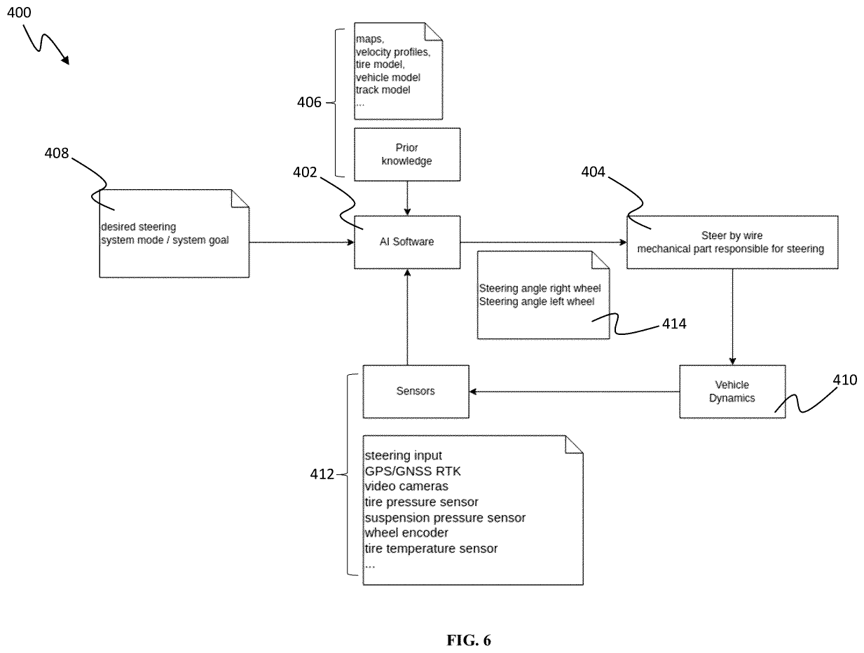

Referring to FIG. 5, a block diagram of a steer-by-wire subsystem 300 is depicted, according to an embodiment. Steer-by-wire subsystem 300 eliminates the physical connection between the steering wheel and the wheels of a vehicle by using electrically controlled motors to change the direction of the wheels and to provide feedback to the driver.

In an embodiment, steer-by-wire subsystem 300 generally comprises a steering wheel 302, a feedback actuator 304, a controller 306, a wheel actuator 308 and one or more wheels 310. As illustrated in FIG. 5, steering wheel 302 comprises a physical steering wheel. In embodiments, steering wheel 302 is a joystick. In an embodiment, there is no mechanical link between steering wheel 302 and wheel 302 steering angles. Information for steering wheel 302 can be used as input to artificial intelligent software, as will be described.

In operation, feedback actuator 304 generates the steering feel and passes the steering signal “by-wire” quickly and precisely, as controlled by controller 306, to wheel actuator 308, which steers wheel 310. More particularly, the mechanical portion of embodiments described herein include independent steering control of each wheel, such that system inputs of desired wheel steering angles can be provided, and an expected output is changed wheel steering angles. For example, controller 306 can include a processor including software for controlling wheel 310 according to an optimal slip angle steering control. In embodiments, controller 306 can be operably coupled to a control module of an AI subsystem configured to command control instructions for the one or more wheels 310.

As illustrated in FIG. 5, wheel 310 is depicted with its own wheel actuator 308. In embodiments, each wheel of the vehicle can include an associated wheel actuator 308 for independent control of each wheel. In other embodiments, the front wheels (but not the rear wheels) of the vehicle can include an associated wheel actuator 308 for independent control of each front wheel.

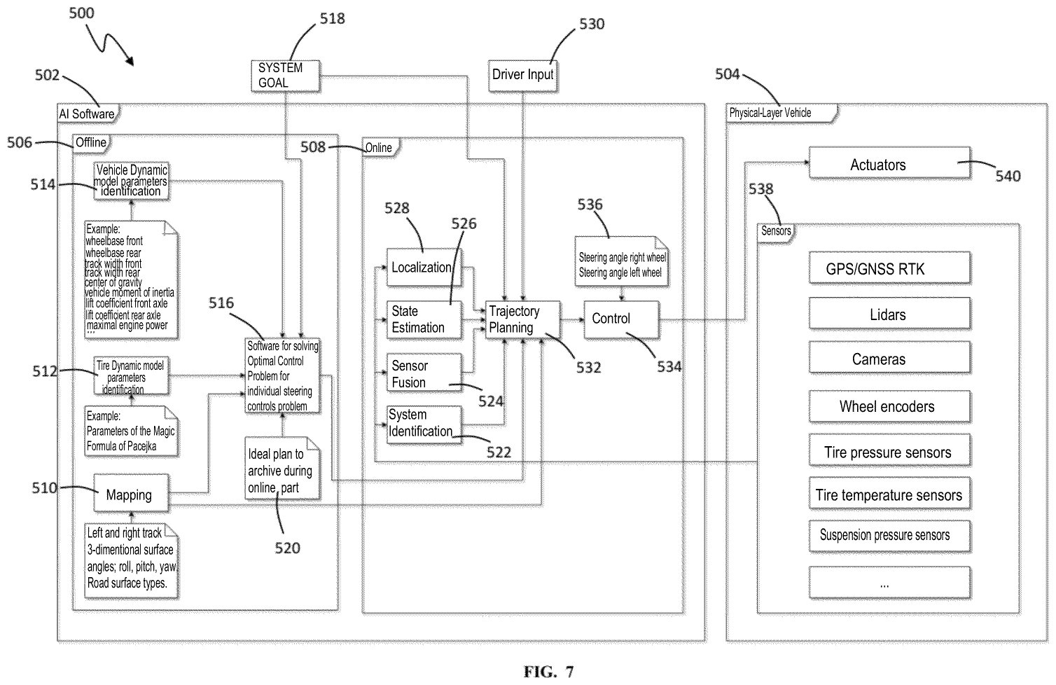

Referring to FIG. 6, a block diagram of a system 400 for optimal slip angle steering control of a vehicle is depicted, according to an embodiment. System 400 generally comprises an artificial intelligence (AI) subsystem 402 and a steer-by-wire subsystem 404. AI subsystem 402 generally comprises AI algorithms that can implement one or more: first principles models, optimization-based models, machine learning models trained to determine optimal steering angles for implementation on a vehicle by steer-by-wire subsystem 404. More particularly, AI subsystem 402 uses information from different sources (driver steering input, maps, GPS, video cameras, tire pressure sensor, suspension pressure sensor, wheels encoders, temperature sensors, etc.) to compute the optimal steering angle for a given wheel (e,g. each controllable wheel). In an embodiment, AI subsystem 402 is configured to compute optimal steering angles based on current car dynamic state and prior information about the vehicle's environment. In embodiments, an optimal steering angle for a given wheel is determined for various moments in time, including at 1 ms, 2 ms, 3 ms, 4 ms, 5 ms, 10 ms, and so on.

As described herein, system 400 can include various engines or modules, each of which is constructed, programmed, configured, or otherwise adapted, to autonomously carry out a function or set of functions. The term engine as used herein is defined as a real-world device, component, or arrangement of components implemented using hardware, such as by an application specific integrated circuit (ASIC) or field-programmable gate array (FPGA), for example, or as a combination of hardware and software, such as by a microprocessor system and a set of program instructions that adapt the engine to implement the particular functionality, which (while being executed) transform the microprocessor system into a special-purpose device. An engine can also be implemented as a combination of the two, with certain functions facilitated by hardware alone, and other functions facilitated by a combination of hardware and software. In certain implementations, at least a portion, and in some cases, all, of an engine can be executed on the processor(s) of one or more computing platforms that are made up of hardware (e.g., one or more processors, data storage devices such as memory or drive storage, input/output facilities such as network interface devices, video devices, keyboard, mouse or touchscreen devices, etc.) that execute an operating system, system programs, and application programs, while also implementing the engine using multitasking, multithreading, distributed (e.g., cluster, peer-peer, cloud, etc.) processing where appropriate, or other such techniques. Accordingly, each engine can be realized in a variety of physically realizable configurations and should generally not be limited to any particular implementation exemplified herein, unless such limitations are expressly called out. In addition, an engine can itself be composed of more than one sub-engines, each of which can be regarded as an engine in its own right. Moreover, in the embodiments described herein, each of the various engines corresponds to a defined autonomous functionality; however, it should be understood that in other contemplated embodiments, each functionality can be distributed to more than one engine. Likewise, in other contemplated embodiments, multiple defined functionalities may be implemented by a single engine that performs those multiple functions, possibly alongside other functions, or distributed differently among a set of engines than specifically illustrated in the examples herein.

For example, portions of AI subsystem 402 and steer-by-wire subsystem 404 can be implemented on computing components integrated into a vehicle. In embodiments, other portions can be implemented on computing components remote from the vehicle and operably coupled to the vehicle, such as a communicative coupling over a network.

In an embodiment, system 400 further comprises components of AI subsystem 402 and steer-by-wire subsystem 404 or components used by AI subsystem 402 and steer-by-wire subsystem 404. For example, system 400 can further comprise prior knowledge data 406, a desired steering data 408, vehicle dynamics data 410, sensors 412, and one or more steering angle commands 414.

In an embodiment, system 400 further comprises prior knowledge data 406. In an embodiment, prior knowledge data 406 can include maps, velocity profiles, tire models, vehicle models, track models, and so on. In an embodiment, prior knowledge data 406 can include training data for one or more machine learning models. In embodiments, prior knowledge data 406 can itself include one or more machine learning models. In embodiments, AI subsystem 402 can include AI algorithms that can implement one or more: first principles models, optimization-based models, machine learning models trained by prior knowledge data 406. Accordingly, prior knowledge data 406 is an input to AI subsystem 402.

In an embodiment, system 400 further comprises desired steering data 408. System 400 inputs as desired steering data 408 can include a desired steering angle/desired path curvature, one or more system goals, such as minimum possible time, tire saving, tire warm-up. In an embodiment, and as will be explained further, a goal can be chosen by a system administrator (team manager, car operator, driver etc.). In another embodiment, a goal can be determined by AI subsystem 402 based on one or more: first principles models, optimization-based models, machine learning models trained by prior knowledge data (e.g. a racing strategy with a goal to get the highest position (highest points) in the race).

In an embodiment, system 400 further comprises vehicle dynamics 410. In an embodiment, in response to steer-by-wire subsystem 404, vehicle dynamics 410 are changed. More particularly, vehicle dynamics 410 reflect the motion of the vehicle generated by the steering action of steer-by-wire subsystem 404. In an embodiment, vehicle dynamics includes a plurality of vehicle data utilized by one or more: first principles models, optimization-based models, machine learning models trained.

In an embodiment, system 400 further comprises sensors 412. In an embodiment, sensors 412 can include steering input, GPS/Global Navigation Satellite System Real Time Kinematics (GNSS RTK), video cameras, tire pressure sensors, suspension pressure sensors, wheel encoders, tire temperature sensors, etc. For example, sensors 412 can capture data associated with vehicle dynamics 410. Data captured by sensors 412 can be input to AI subsystem 402 for use in determining optimal slip angles.

In an embodiment, system 400 further comprises one or more steering angle commands 414. For example, AI subsystem 402 can output one or more steering angle commands 414 as a steering angle for the right front wheel and a steering angle for the left front wheel, which can be input to steer-by-wire subsystem 404.

Steer-by-wire subsystem 404 includes one or more actuators to execute commands from AI subsystem 402 to control one or more vehicle wheels. In one embodiment, steer-by-wire subsystem 400 can be substantially similar to steer-by-wire subsystem 300.

In operation, AI subsystem 402 receives as inputs prior knowledge data 406, desired steering data 408, and data captured by sensors 412. Using one or more of machine learning models, first principles models, optimization-based models, or mathematical algorithms, AI subsystem 402 outputs one or more steering angle commands 414. Steer-by-wire subsystem 404 receives as input one or more steering angle commands 414 and implements the commanded slip angle for one or more wheels of the vehicle.

Referring to FIG. 7, a block diagram of a system 500 for optimal slip angle steering control of a vehicle is depicted, according to an embodiment. In an embodiment, system 500 further depicts portions of system 400 as illustrated in FIG. 6 but which are renumbered here for ease of explanation.

In an embodiment, system 500 generally comprises an AI layer 502 and a physical layer 504. In an embodiment, AI layer 502 comprises artificial intelligent software configured to compute optimal steering angles based on current car dynamic state and prior information about the vehicle environment. In an embodiment, physical layer 504 is configured to operate on the vehicle. As described herein, system 500 can include various engines or modules.

AI layer 502 generally comprises an offline engine 506 and an online engine 508. In an embodiment, offline engine 506 is generally configured to collect and process prior information about the environment of the vehicle. Put another way, offline engine 506 obtains and processes data associated with the question of “what is the environment?” in order to develop an ideal plan for the car, thereby solving the optimal control problem.

In an embodiment, offline engine 506 generally comprises a mapping module 510, a tire identification module 512, a vehicle identification module 514, and an optimal control module 516. Offline engine 506 takes one or more system goals 518 as input and can be further configured to generate an ideal plan 520 for the vehicle.

Mapping module 510 is configured for generating, retrieving, and/or storing information about the environment map in which vehicle is placed. In an embodiment, mapping module 510 can determine on environmental parameters including track configuration, left and right track borders, surface properties (e.g. three-dimensional track surface properties, type of surface, coefficient of friction), track surface angles: roll, pitch, yaw of racing line, and road surface types. In a particular embodiment, mapping module 510 can include track configuration data (e.g. the shape, length, width, etc. of the track) and track friction data (e.g. data capturing the particular interface between the vehicle and the surface of the track). In an embodiment, mapping module 510 is configured to include or interface with sources of information including a GPS map, drone photographs, or other AI to obtain environment map data. In an embodiment, mapping module 510 can be operably coupled to a data storage such as a database for storing raw, synthesized, and intermediate environmental data. In an embodiment, mapping module 510 can implement a machine learning model trained on map data. For example, a mapping model can utilize known map data such as similar tracks, similar environments, similar surfaces, etc., in order to predict or otherwise generate mapping data for the specific environment map in which vehicle is placed.

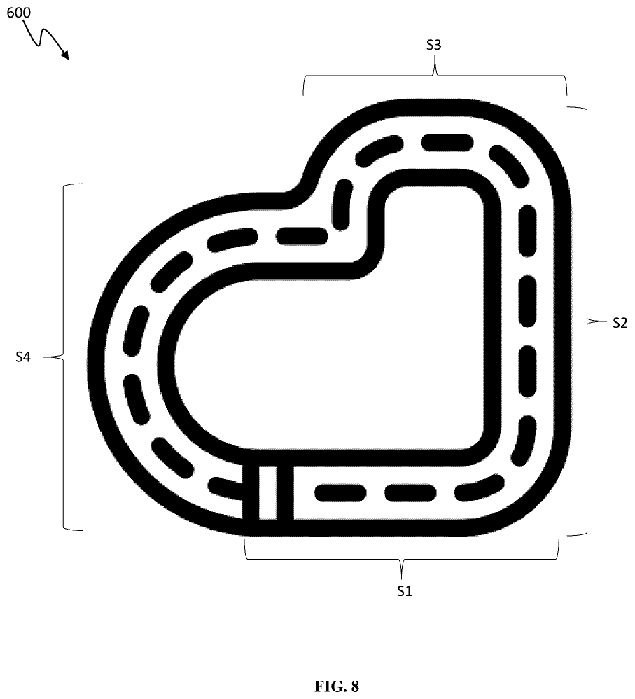

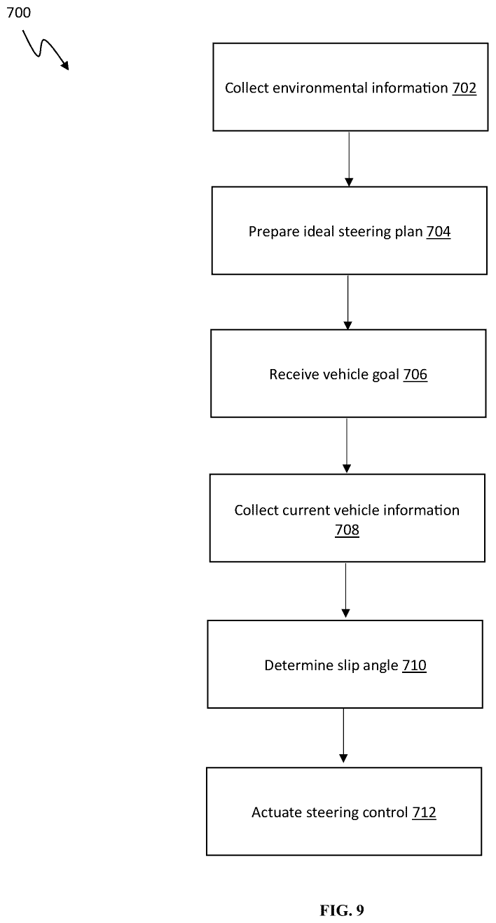

Referring further to FIG. 8, a block diagram of a track 600 is depicted, according to an embodiment. Track 600 includes a plurality of segments S1, S2, S3, S4. Segment S1 can be considered a first straightaway. Segment S2 can be considered a second straightaway. Segment S3 can be considered a first turn portion. Segment S4 can be considered a second turn portion. Track 600 can be broken into further segments (e.g. the turn coupling S1 and S2, the turn coupling between S2 and S3, etc.), but is depicted in segments S1-S4 for ease of illustration. In an embodiment, mapping engine 510 can determine the various segments of track 600.

Accordingly, mapping engine 510 is configured to parse track 600 into meaningful segments based on existing vehicle operation data (e.g. vehicles on turns operate differently than vehicles on straightaways). Further, mapping engine 510 can determine characteristics relative to the plurality of segments (e.g. length of straightway compared to incoming and outgoing turn, tightness of turn, etc.). Accordingly, mapping engine 510 can parse track 600 into segments representing the entire track or one or more portions of the track.

Tire identification module 512 is configured for generating, retrieving, and/or storing information about the tires of the vehicle. In an embodiment, tire identification module 512 can determine tire dynamic model parameters. In one example, data can include the Magic Formula (Pacejka) tire model for the longitudinal force. In an embodiment, tire identification module 512 is configured to include or interface with sources of information including one or more tire manufacturers. For example, tire identification module 512 can be communicatively coupled to networked sources of information. In an embodiment, tire identification module 512 is configured to implement experiments (ex: tire test stand) to obtain vehicle tire data. In an embodiment, tire identification module 512 is configured to interface with AI configured to determine tire dynamic model parameters. In an embodiment, tire identification module 512 can be operably coupled to a data storage such as a database for storing raw, synthesized, and intermediate tire data.

Vehicle identification module 514 is configured for generating, retrieving, and/or storing information about the vehicle. In an embodiment, vehicle identification module 514 can determine dynamic model parameters. In one example, data can include vehicle physical dimensions, vehicle mass, vehicle drag coefficient, vehicle aerodynamic downforce, etc. In an embodiment, vehicle identification module 514 is configured to include or interface with sources of information including vehicle manufacturers. For example, vehicle identification module 514 can be communicatively coupled to networked sources of information. In an embodiment, vehicle identification module 514 is configured to implement experiments (ex: aerodynamic tunnel) to obtain vehicle data. In an embodiment, vehicle identification module 514 is configured to interface with AI configured to determine vehicle dynamic model parameters. In an embodiment, vehicle identification module 514 can be operably coupled to a data storage such as a database for storing raw, synthesized, and intermediate vehicle data.

Optimal control module 516 comprises one or more models configured for solving the optimal control problem. In an embodiment, ideal plan 520 is the model output of optimal control module 516. In an embodiment, optimal control module 516 can include a plurality of dimensions to extract 100% performance of the vehicle. Human limitations of the vehicle are thereby overcome.

In one embodiment, optimal control module 516 implements a mathematical model described by a system by a set of variables and a set of equations that establish relationships between the variables. For example, mapping module 510, tire identification module 512, and vehicle identification module 514 can define the various variables and their relationships associated with the vehicle. Optimal control module 516 can utilize these variables to implement a set of equations to control the vehicle at future points in time. In an embodiment, optimal control module 516 can further include training based on system goal 518. For example, certain variables or equations created by mapping module 510, tire identification module 512, and vehicle identification module 514 can be prioritized or de-prioritized based on system goal 518. In an embodiment of a mathematical model, a dynamic model includes dynamical methods, which are applied based on the current goal(s), and the resulting output is slip angle at each moment in time.

In another embodiment, optimal control module 516 implements a neural network trained on data related to the vehicle. More particularly, optimal control module 516 can implement one or more machine learning models. For example, mapping module 510, tire identification module 512, and vehicle identification module 514 can generate training data for training one or more machine learning models. One or more machine learning models implemented on one or more neural networks can be therefore trained to control the vehicle at future points in time. In an embodiment, optimal control module 516 can further include training based on system goal 518. For example, feature vectors created by mapping module 510, tire identification module 512, and vehicle identification module 514 can be selected, de-selected, or prioritized for training based on system goal 518. In an embodiment of a trained neural network, inputs of the current goal(s) are applied to neurons, and the resulting output is slip angle at each moment in time.

As described above, optimal control module 516 is illustrated as implementing a mathematical model or a machine learning model. The mathematical model and machine learning model described herein are for illustration only. The models utilized are not limited to these embodiments.

In an embodiment, optimal control module 516 is configured to utilize map segments from mapping module 510 relative to an average speed for a specified segment (lap, several laps, particular part of the track, etc.) or time (1 min, 1 hour, 5 min, etc). For example, based on vehicle identification module 514, and a system goal set as average speed, an average vehicle speed will be known. In an embodiment, mapping module 510 can be configured to break the track into an appropriate number of segments for the vehicle at issue. In embodiments, different numbers of segments can be utilized for different approaches. In one example, more segments are used for higher performing vehicles. In another example, in an optimization numerical method, a grid or other segmenting of the map into map segments can be utilized to appropriately segment the map. In an embodiment, the number of map segments can be associated with a system goal. In another embodiment, optimal control module 516 can update map segments provided by mapping module 510. Generally, segments broken out based on speed such that optimal control module 516 can plan ahead for future areas. In embodiments, the map is moved relatively “forward” because of higher speeds. For example, a race car will not necessarily “see” a turn due to the higher speed compared to a public car.

System goal 518 comprises one or more goals of vehicle operation. In an embodiment, system goal 518 comprises a plurality of goals such that vehicle operation can be dynamically updated or changed. For example, from time T0-T1, system goal 518 can be a first goal G1 from the plurality of goals. From time T1-T2 system goal 518 can be a second goal G2 from the plurality of goals. Certain goals from the plurality of goals can be utilized based on vehicle operation. For example, goals can be implemented based on a vehicle's status during the race, including vehicle and environmental data.

In one example, system goal 518 can be optimal force generation for the fastest cornering. In racing, one of the most important tasks during the race or race qualification is to achieve a minimal lap time. Accordingly, the vehicle should be controlled at its maximum performance and utilize optimally the friction forces generated by tires. Toe angle can be controlled and changed to give maximum grip during the cornering and reduce friction on the straight segments. It is possible to have maximum possible lateral tire force. Accordingly, cornering speed can be increased compared to the static Ackerman steering configuration.

In another example, system goal 518 can be associated with tire temperature management. During a race, there are some periods when the tires need to be warmed up to achieve the best performance. A tire warm up procedure can be improved with control by changes of toe angle. Thus, it is possible to control tire temperature by changing tire slip angle. For example, it is possible to change toe angle on a straightaway to increase tire temperature. It is also possible to control part of the tire being warmed; toe in for inside, toe-out for inside.

In another example, system goal 518 can be associated with tire wearing management. During a race it is also important to control tire degradation to provide desirable grip level during the whole race. At some point of the race, tire utilization can be at its maximum. However, sometimes it is important to keep tire utilization lower to keep tires alive during the whole race. Slip angles play a major role in tire wearing degradation. Thus, reducing slip angle reduces tire degradation.

In another example, system goal 518 can be associated with car stability management through toe control. During a race it is also important to control car stability. For example, on a straight segment and at high speeds, the vehicle could be less responsive, but during turns, sensitivity of the steering should be higher. “Toe in” makes the car more stable (but reduces steering response time and sensitivity). Accordingly, slip angles can reflect small toe-in on a straight and zero toe during cornering.

In an embodiment, one or more system goals 518 can be utilized to train various models in an “offline” processing portion; for example, offline engine 506 (e.g. as an input to optimal control module 516). In an embodiment, one or more system goals 518 can be further utilized to actively set slip angles in an “online” processing portion; for example, online engine 508 (e.g. as an input to trajectory planning module 532).

Accordingly, offline engine 506 is configured for preparation operations to solve for ideal steering, (e.g. “what should the vehicle do?”) in light of future “online” data. In an embodiment, offline engine 506 creates an optimal ideal plan 520 for the car by solving the optimal control problem (e.g. individual steering controls problem) for one or more vehicle goals.

In an embodiment, online engine 508 is generally configured to collect and process current data associated with the vehicle. Put another way, online engine 508 obtains and processes data associated with questions related to the current state of the vehicle. In an embodiment, online engine 508 solves a localization problem of “Where is the vehicle on the map?” In an embodiment, online engine 508 solves a state estimation problem of “What is the current dynamic state?” In an embodiment, online engine 508 solves a system identification problem of “Do we have the right parameters? In an embodiment, online engine 508 solves a trajectory planning problem of “Where is the vehicle going?” In an embodiment, online engine 508 solves a control problem of “What control should the vehicle have?”

In an embodiment, online engine 508 generally comprises a system identification module 522, a sensor fusion module 524, a state estimation module 526, a localization module 528, a trajectory planning module 532, and a control module 534. In embodiments, online engine 508 further utilizes as input one or more system goals 518 and a driver input 530.

System identification module 522 is configured to determine static and dynamic parameters of the vehicle during vehicle operation. For example, parameters can include tire model parameters, car dynamics parameters, environmental parameters (road friction, temperature, humidity etc.) In an embodiment, system identification module 522 can include a mathematical model of the vehicle's dynamic systems using measurements of the input and output signals of the vehicle. In an embodiment, system identification module 522 can include a machine learning model trained based on the vehicle's dynamic systems. System identification module 522 can measure the input and output signals from the car system against time.

System identification module 522 can implement optimization solutions including least-squares fitting. System identification module 522 is further configured to determine whether to update the parameters of the models.

Sensor fusion module 524 is configured to synthesize data from a plurality of sensors (e.g. sensors 538). By fusing data from multiple sources, the resulting information has less uncertainty than when these sources are used individually. In an embodiment, sensor fusion module 524 is configured according to a mathematical model of the various sensors and data associated with the vehicle. In an embodiment, sensor fusion module 524 can include a machine learning model trained based on sensors and data associated with the vehicle. In an embodiment, sensor fusion module 524 is configured to implement sensor fusion using Kalman filters or particle filters.

State estimation module 526 is configured to determine the current state of a complex system of a car based on information from different sensors and vehicle response to control inputs. In an embodiment, state estimation module 526 is configured according to a mathematical model of the possible states relative to sensor data. In an embodiment, state estimation module 526 can include a machine learning model trained based on possible states and associated sensor data.

Localization module 528 is configured to determine where the vehicle is located on the map or track. Localization is one of the most fundamental competencies required by an algorithm to set specific configuration of slip. In an embodiment, localization module 528 is configured according to a mathematical model associated with location variables and can be relative to a particular track. In an embodiment, sensor localization module 528 can include a machine learning model trained based on location of a vehicle relative to a particular track. In an embodiment, localization module 528 is configured to implement localization algorithms such as Montecarlo localization, or camera-based localization.

Trajectory planning module 532 is configured to receive data from offline engine 506 as an input; in particular, ideal plan 520 is communicated to trajectory planning module 532 via optimal control module 516. Trajectory planning module 532 is further configured to receive data from other modules of online engine 508; data from system identification module 522, sensor fusion module 524, state estimation module 526, and localization module 528. Accordingly, trajectory planning module 532 is configured to process the inputs according to a desired trajectory and output a trajectory plan. In an embodiment, trajectory planning module 532 is configured to implement, for example, A*, Dijkstra's algorithm; or optimization-based. In another embodiment, trajectory planning module 532 can be implemented as a machine learning model.

In an embodiment, driver input 530 can be received as an input to trajectory planning module 532; for example, a steering wheel input. Driver input 530 can include steering wheel actuator measurement of a driver's expectation on what the vehicle should do. In embodiments, trajectory planning module 532 is further configured to execute based on a driver's intention (e.g via driver input 530).

In an embodiment, trajectory planning module 532 is configured to dynamically update trajectory based on past performance. For example, a machine learning model can be updated with a feedback loop based on how the vehicle has already performed on those map segments. In another example, trajectory planning module 532 can react to environmental conditions (e.g. from sensor fusion module 524). Consider a case in which it is starting to rain proximate the vehicle. Trajectory planning module 532 can adapt to new conditions to account for the new conditions. Accordingly, trajectory planning module 532 can implement continuous trajectory updating.

Control module 534 is configured to receive a trajectory plan from trajectory planning module 532 as input and output one or more slip angles 536, such as steering angle right wheel and steering angle left wheel, as illustrated in FIG. 7. One or more slip angles 536 are commanded to physical layer 504 for implementation on the wheels of the vehicle. In an embodiment, control module 534 utilizes control algorithms for example first principles models, optimization-based models, machine learning models trained, or any other algorithm, graph-based method, clothoid-based method, spline based method, model predictive path integral control, model predictive control (MPC) control algorithm to optimize a system goal (e.g. desired behavior). In an embodiment, MPC uses mathematical models and predictive algorithms to anticipate future conditions and automate how a system should respond.

In an embodiment, control module 534 can update control commands for physical layer 504. In embodiments, control commands are updated at 1 ms, 2 ms, 3 ms, 4 ms, 5 ms, 6 ms, 7 ms, 8 ms, 9 ms, 10 ms, and so on. In embodiments, control commands can be updated according to update periods in microseconds. Advantageously, more frequent updates to control commands more precisely control the vehicle. Embodiments are more effective than human reactions (which is around 100 ms) and can be at a faster rate than 100 ms. Embodiments therefore control with smaller steps of time and with smaller gradient, in contrast to existing solutions. In embodiments, updating at a rate faster than 1 time per second (Hz) is an improvement due to the speed of the car and distance traveled.

In an embodiment, one or more of the models of online engine 508 can be adjusted based on complexity constraints in light of a goal. In one example, a primary goal can be the fastest lap possible (e.g. during qualification). But, during the actual race, the goal is fastest average speed. Accordingly, system goal 518 can comprise sub-goals or multiple goals. Sub-goals can be implemented according to a vehicle benchmark (e.g. tires reached end of life), or according to a certain timeline (e.g. after Tx, goal changes from G1 to G2).

For example, during a race, system goal 518 can change (e.g. overtake a car our vehicle is stuck behind, forget about fastest lap possible), then once overtaken, maximize to get fastest average speed. In another example of a yellow flag, system goal 518 can change to be keep tires warm, but don't overutilize so reduce the angles. Subgoals can be to not change anything but take a pit stop (pit stop is input to the system), or as part of the system, don't save tires because a pit stop is coming up.

Physical layer 504 of the vehicle generally includes a plurality of sensors 538 and one or more actuators 540.

Plurality of sensors 538 can include various hardware and software devices configured to determine dynamic data associated with the vehicle. In an embodiment, sensors 538 can include GPS/GNSS RTK, lidars, cameras, wheels encoders, tire pressure sensors, tire temperature sensors, suspension pressure sensors, etc.

In embodiments, data obtained by plurality of sensors 538 can be input back to AI layer 502. In an embodiment, models can be retrained according to data obtained by plurality of sensors 538. For example, upon input to AI layer 502, trajectory planning module 532 can account for an anti-lock brake relationship as sensed by plurality of sensors 538. For example, slip angle can be controlled for longitudinal control.

One or more actuators 540 are configured to mechanically adjust the one or more wheels of the vehicle according to a steering angle commanded by control module 534. More particularly, actuators 540 execute the command and set the requested steering angles. In an embodiment, one or more actuators 540 are substantially similar to wheel actuator 308 described in FIG. 6.

Referring to FIG. 9, a flowchart of a method 700 for slip angle steering control of a vehicle is depicted, according to an embodiment. In an embodiment, method 700 can be implemented according to the systems discussed herein. More particularly, method 700 can be utilized for slip angle steering control of a vehicle implementing steer-by-wire including independent steering control for at least one wheel of the vehicle. For example, reference is made further herein to FIGS. 5-6 and systems 300, 400.

At 702, environmental information about the vehicle is collected. In an embodiment, the environmental information can include at least a track or path configuration and at least one vehicle parameter. For example, prior knowledge data 406 can include a track the vehicle will be operating on, and a vehicle parameter such as velocity profiles, tire models, or vehicle models.

At 704, an ideal steering plan for the vehicle is prepared using a model based on the environmental information. For example, AI subsystem 402 can generate an ideal plan as part of a model. The ideal plan can be an optimal control plan based on prior knowledge data 406 as applied to one or more models. In an embodiment, the optimal control plan is implemented as, for example, a neural network or a mathematical model.

At 706, at least one vehicle goal is received. For example, system goal 408 can be input to AI subsystem 402. In an embodiment, a plurality of system goals 408 can be input to AI subsystem 402. Accordingly, an initial goal and a number of subsequent goals can be input or input through the operation of method 700.

At 708, current vehicle information is collected. In an embodiment, current vehicle information can include identification data, mapping data, localization data, sensor data, and state estimation data for the vehicle. For example, sensors 412 can collect data regarding vehicle dynamics 410 for input into AI subsystem 402.

At 710, a slip angle for the at least one wheel is determined. In an embodiment, a slip angle can be determined based on the current vehicle information applied to the model for the at least one vehicle goal. For example, AI subsystem 402 can determine one or more slip angles such as steering angles 414.

At 712, the independent steering control for the at least one wheel of the vehicle is actuated according to the slip angle determined at 710. AI subsystem 402 can input the one or more slip angles into steer-by-wire subsystem 404. Referring also to steer-by-wire subsystem 300, wheel 310 can be actuated using wheel actuator 308.

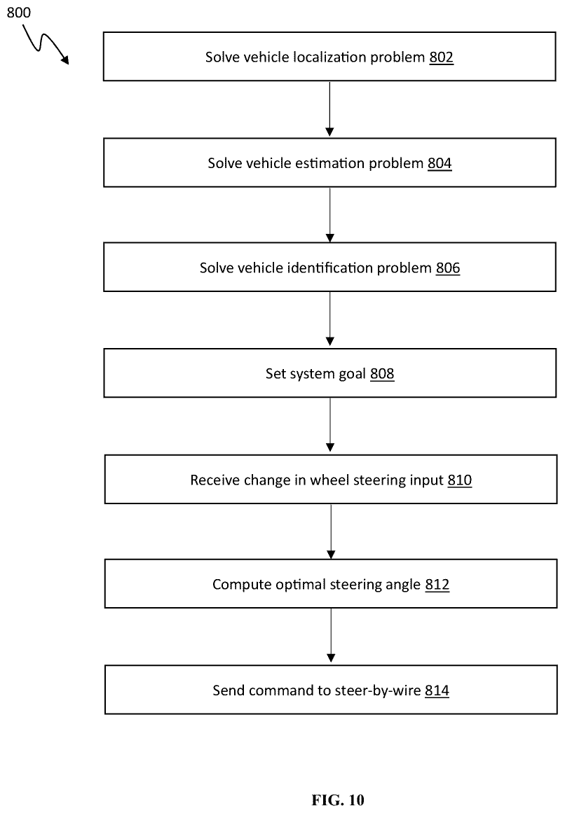

Referring to FIG. 10, a flowchart of a method 800 for slip angle steering control of a vehicle is depicted, according to an embodiment. In an embodiment, method 800 can be implemented according to the systems discussed herein. In an embodiment, method 800 reflects the software pipeline for the artificial intelligence subsystems discussed herein. For example, reference is made further herein to FIG. 7 and AI subsystem 502. In embodiments, method 800 can be utilized for slip angle steering control of a vehicle implementing steer-by-wire including independent steering control for at least one wheel of the vehicle.

In an embodiment, systems implementing method 800 generally utilize hardware including sensors to solve mapping, localization, estimation, system identification, and control problems, such as GPS, GNSS RTK, lidars, cameras, wheels encoders, tire pressure sensors, suspension pressure sensors, and so on.

Systems implementing method 800 can further include at least one processor and an operably coupled memory. Accordingly, memory can include instructions that, when executed on the at least one processor, cause the at least one processor to implement method 800.

At 802, a localization problem for the vehicle is solved. In an embodiment, localization determines the vehicle location relative to the environment. Localization is often called position estimation or position tracking. In embodiments, vehicle tasks require knowledge of the location of the vehicle (although not necessarily within a global map). For example, localization module 528 can determine where the vehicle is located on a map or track.

At 804, an estimation problem for the vehicle is solved. In an embodiment, solving the estimation problem defines the current dynamic state of the vehicle. The state estimation of a vehicle involves fusing the raw information provided by the sensors and the system model. For example, sensor fusion module 524 can combine data from one or more sensors 538, and state estimation module 526 can determine the current state of the vehicle based on information from different sensors and vehicle response on control inputs.

At 806, an identification problem for the vehicle is solved. In an embodiment, solving the identification problem defines static and dynamic parameters of the vehicle and its environment. System identification (SI) can include building models for the systems from the given input-output data. The notion of modeling is applied to model the systems so as to understand their hidden behavior and predict its characteristics. For example, system identification module 522 can determine static and dynamic parameters such as tire model parameter, car dynamics parameters, environmental parameters (road friction, temperature, humidity etc.)

At 808, one or more system goals can be generated as input to the system implementing method 800. Example system goals can include optimal steering, temperature management, tire wearing management, stability management, etc. For example, system goal 518 can be generated and input to optimal control module 516.

At 810, a change in wheel steering can be received as input to the system implementing method 800. For example, driver input 530 of steering wheel manipulation can be input to trajectory planning module 532.

At 812, one or more optimal steering angles are computed. In an embodiment, a steering angle can be calculated for each steerable wheel. For example, a steering angle can be calculated for all wheels. In other embodiments, a steering angle can be calculated for less than all steerable wheels. For example, a steering angle can be calculated for the right front wheel and the left front wheel (when the rear wheels are fixed). In an embodiment, control module 534 can output steering angles 536.

At 814, a command of the steering angles is sent to the steer-by-wire subsystem. For example, control module 534 can command actuators 540 to actuate the wheels of the vehicle according to its steer-by-wire physical layer 504.

1. A method for controlling a vehicle implementing steer-by-wire including independent steering control for at least one wheel of the vehicle, the method comprising:
collecting environmental information about the vehicle, the environmental information including a track configuration and at least one vehicle parameter;
preparing an ideal steering plan for the vehicle using a model based on the environmental information;
receiving at least one vehicle goal;
collecting current vehicle information including identification data, mapping data, localization data, sensor data, and state estimation data for the vehicle;
determining a slip angle for the at least one wheel based on the current vehicle information applied to the model for the at least one vehicle goal; and
actuating the independent steering control for the at least one wheel of the vehicle according to the slip angle.

2. The method of claim 1, wherein the model is at least one of:
a mathematical model including a set of variables and a set of equations establishing relationships between the variables; or
a machine learning model implemented on a neural network.

3. The method of claim 1, wherein the at least one vehicle goal is at least one of optimal force generation, tire temperature management, tire wearing management, or car stability management.

4. The method of claim 1, wherein the identification data includes static and dynamic parameters related to input and output signals of the vehicle.

5. The method of claim 1, wherein the mapping data includes the track configuration and friction data.

6. The method of claim 1, wherein the localization data includes a location of the vehicle relative to the track configuration.

7. The method of claim 1, wherein the sensor data includes a plurality of sensor data related to the vehicle.

8. The method of claim 1, wherein the state estimation data includes a current state of the vehicle.

9. The method of claim 1, wherein receiving at least one vehicle goal comprises receiving a second goal, and wherein determining the slip angle for the at least one wheel based on the current vehicle information applied to the model for the at least one vehicle goal includes updating the slip angle based on the second goal.

10. A system for controlling a vehicle using at least one system goal, the system comprising:
a plurality of sensors configured to detect data associated with the vehicle;
an artificial intelligence (AI) subsystem including:
an offline engine configured to operate on existing information associated with the vehicle, the offline engine including an optimal control module configured to generate an ideal plan as a model for the vehicle based on mapping data, tire dynamics data, and vehicle dynamics data; and
an online engine configured to operate on dynamic data associated with the vehicle, the online engine including:
an identification module configured to determine static and dynamic vehicle parameters during vehicle operation,
a sensor fusion module configured to synthesize data from a plurality of sensors associated with the vehicle to generate fused data,
a state estimation module configured to determine a current state of the vehicle based on the fused data,
a localization module configured to determine a location of the vehicle,
a trajectory planning module configured to determine at least one slip angle for a wheel of the vehicle based on the at least one system goal applied to the ideal plan, according to the static and dynamic vehicle parameters during vehicle operation, the current state of the vehicle, and the location of the vehicle, and
a control module configured to generate a command according to the slip angle; and
a steer-by-wire subsystem including an actuator associated with at least one wheel of the vehicle for independent steering control of the at least one wheel and configured to actuate the at least one wheel according to the command.

11. The system of claim 10, wherein the model is at least one of:
a mathematical model including a set of variables and a set of equations establishing relationships between the variables; or
a machine learning model implemented on neural network.

12. The system of claim 10, wherein the at least one system goal includes a first goal and a second goal, wherein the trajectory planning module is further configured to update the at least one slip angle based on the second goal.

13. The system of claim 10, wherein the trajectory planning module is further configured to receive a driver input as a driver's expectation for the vehicle and calculate the at least one slip angle based on the driver's expectation.

14. The system of claim 10, wherein the offline engine further comprises:
a mapping module configured to generate the mapping data about the environment in which the vehicle is placed by analyzing a track according to a mapping model,
a vehicle identification module configured to determine the tire dynamics data by analyzing the tire according to a tire model, and
a tire dynamics module configured to determine the vehicle dynamics data by analyzing the vehicle according to a vehicle model.

15. The system of claim 14, wherein the environment in which the vehicle is placed is a track and the mapping module is further configured to parse the track into a plurality of segments, and wherein the optimal control module is configured to utilize the plurality of segments according to a vehicle parameter.

16. The system of claim 15, wherein a number of the plurality of segments is associated with the at least one system goal.

17. The system of claim 10, wherein the trajectory planning module is configured to dynamically update the at least one slip angle based on past performance of the vehicle.

18. A method for controlling a vehicle, the method comprising:
solving a localization problem for the vehicle by determining a location of the vehicle;
solving an estimation problem for the vehicle by determining a current state of the vehicle;
solving an identification problem for the vehicle by determining static and dynamic vehicle parameters during vehicle operation;
generating at least one system goal;
receiving a change in wheel steering input;
computing at least one steering angle for a wheel of the vehicle based on the at least one system goal, the location of the vehicle, the current state of the vehicle, and the static and dynamic vehicle parameters; and
commanding a steer-by-wire subsystem to actuate the wheel of the vehicle according to the at least one steering angle.

19. The method of claim 18, wherein the at least one system goal is updated during vehicle operation and wherein computing the at least one steering angle comprises dynamically updating the at least one steering angle during vehicle operation based on the updated at least one system goal.

20. The method of claim 18, further comprising generating a model of an ideal steering control plan, wherein the computing the at least one steering angle utilizes the model.
